(19) United States
(12) Patent Application Publication
(10) Pub. No.: US 2012/0007983 A1
(43) Pub. Date: Jan. 12, 2012

(54) METHOD AND SYSTEM FOR DETECTING VEHICLE OFFENCES

(76) Inventor: Fraser John Welch, Victoria (AU)

(21) Appl. No.: 13/141,642

(22) PCT Filed: Dec. 23, 2009
(86) PCT No.: PCT/AU2009/001698

§ 371 Date: Aug. 15, 2011

(30) Foreign Application Priority Data
Dec. 24, 2008 (AU) 2008906642

(51) Int. Cl. G06K 9/00; H04N 7/18

(52) U.S. Cl. 348/148; 382/104; 348/E07.085

(57) ABSTRACT

Methods and systems for uniquely identifying a vehicle that has committed a potential violation are disclosed. One method comprises the steps of: obtaining first data for uniquely identifying vehicles that enter a zone of interest (610); obtaining second data relating to a potential violation committed by a particular vehicle in the zone of interest (620); correlating the first and second data to identify a portion of the first data recorded while the particular vehicle was present in the zone of interest (630); extracting a unique identifier of the particular vehicle from the first data (640); and recording the unique identifier and an association between the unique identifier and the second data (650).

### FIELD OF THE INVENTION

The present invention relates generally to detecting vehicle offences or violations and more particularly to improved methods and systems for identifying vehicles that have committed an offence such as a parking violation.

### BACKGROUND

An earlier patent application filed in the name of the applicant of the present application, namely International Patent Publication No. WO 2005/111963, which was published on 24 Nov. 2005, describes methods and systems for identifying overstay of vehicles in a parking bay. Such parking bays typically include metered and un-metered parking bays. Overstay beyond an allowed parking duration, in a particular parking bay, is detected by a wireless detector located in or adjacent to the parking bay and is wirelessly communicated to a data collection apparatus for the purpose of alerting an enforcement officer. The data collection apparatus may be hand-carried by the enforcement officer or may be located in a moving vehicle.

Implementation of the methods and systems described in International Patent Publication No. WO 2005/111963 has resulted in an increased number of enforcement instances when compared to the more traditional “chalking of tyres” method. This is clearly due to the more targeted method of alerting an enforcement officer to a violation or potential violation. Nevertheless, investigations have shown that the number of actual enforcement instances is still substantially lower than the number of parking violations in a particular area. The present inventor has identified that a substantial portion of un-enforced potential violations is due to an enforcement officer not being present at the location of the offence or violation when the violation takes place. In summary, it is necessary that an enforcement officer observe the offending vehicle while in an offending state and record its license registration number for enforcement purposes.

A need thus exists for methods and systems that enable a higher percentage of violations to be enforced.

### SUMMARY

An aspect of the present invention provides a method for uniquely identifying a vehicle that has committed a potential violation. The method comprises the steps of: obtaining first data for uniquely identifying vehicles that enter a zone of interest; obtaining second data relating to a potential violation committed by a particular vehicle in the zone of interest; correlating the first and second data to identify a portion of the first data recorded while the particular vehicle was present in the zone of interest; extracting a unique identifier of the particular vehicle from the first data; and recording the unique identifier and an association between the unique identifier and the second data.

Another aspect of the present invention provides a computer system for uniquely identifying a vehicle that has committed a potential violation. The computer system comprises: memory for storing data and software program instructions; an input/output interface for receiving and transmitting data; a video display for displaying information; and at least one processor coupled to the memory, the input/output interface and the video display. The at least one processor is programmed to: obtain, via the input/output interface, first data for uniquely identifying vehicles that enter a zone of interest; obtain second data relating to a potential violation committed by a particular vehicle in the zone of interest; correlate the first and second data to identify a portion of the first data which was recorded while the particular vehicle was present in the zone of interest; extract a unique identifier of the particular vehicle from the first data; and record the unique identifier and an association between the unique identifier and the second data.

Another aspect of the present invention provides a system for capturing images of vehicles to detect potential violations. The system comprises: a battery pack for powering the system; a digital camera for capturing images of the vehicles; a removable memory storage device for storing images captured by the digital camera; a radio transceiver for wirelessly communicating with a plurality of vehicle detectors; and a low-power embedded personal computer coupled to the digital camera, the removable memory storage device, and the radio transceiver. The low-power embedded personal computer is adapted to: capture images of vehicles in a zone of interest; and record the captured images together with a time-stamp on the removable memory storage device. The system is mounted in a backpack and the digital camera is mounted on a shoulder strap of the backpack.

Another aspect of the present invention provides a method for uniquely identifying a vehicle that has committed a potential parking violation. The method comprises the steps of: obtaining first data for uniquely identifying vehicles that enter a parking bay; obtaining second data for determining time of occupancy of said parking bay by a particular vehicle; obtaining third data for determining expiry of paid parking periods for said parking bay; correlating the first, second and third data to identify: occupancy of the parking bay by the particular vehicle during expiry of a paid parking period; and a portion of the first data which was recorded while the particular vehicle was present in the parking bay; extracting a unique identifier of the particular vehicle from the first data; and recording the unique identifier and an association between the unique identifier and at least one of the second and third data.

Another aspect of the present invention provides a computer system for uniquely identifying a vehicle that has committed a potential parking violation. The system comprises: memory for storing data and software program instructions; an input/output interface for receiving and transmitting data; a video display for displaying information; and at least one processor coupled to the memory, the input/output interface and the video display. The at least one processor is programmed to: obtain first data for uniquely identifying vehicles that enter a parking bay; obtain second data for determining time of occupancy of the parking bay by a particular vehicle; obtain third data for determining expiry of paid parking periods for the parking bay; correlate the first, second and third data to: identify occupancy of the parking bay by the particular vehicle during expiry of a paid parking period; and identify a portion of the first data which was recorded while the particular vehicle was present in the parking bay; extract a unique identifier of the particular vehicle from the first data; and record the unique identifier and an association between the unique identifier and at least one of the second and third data.

### BRIEF DESCRIPTION OF THE DRAWINGS

A small number of embodiments are described hereinafter, by way of example only, with reference to the accompanying drawings in which:

FIG. 1 is an overhead view of a roadway to which an embodiment of the present invention is applied;

FIG. 2 is a graphical representation of a magnetic reading file showing an instance of vehicle overstay in accordance with an embodiment of the present invention;

FIGS. 3a, 3b and 3c are line drawings representative of visual images of a vehicle in a parking bay;

FIG. 4 is an overhead view of another roadway to which an embodiment of the present invention is applied;

FIG. 5 is an overhead view of another roadway to which an embodiment of the present invention is applied;

FIG. 6 is a flow diagram of a method for uniquely identifying a vehicle that has committed a potential violation in accordance with embodiments of the present invention;

FIG. 7 is a schematic block diagram of a camera system in accordance with an embodiment of the present invention; and

FIG. 8 is a schematic block diagram of a computer system with which embodiments of the present invention may be practised.

### DETAILED DESCRIPTION

A small number of methods and systems are described hereinafter for uniquely identifying vehicles that have committed a potential offence or violation.

While certain of the embodiments described hereinafter relate specifically to parking offences or violations, the present invention is not intended to be limited in this manner. For example, embodiments of the present invention may be practised in relation to numerous different types of parking or traffic offences or violations such as stopping in a location where stopping is not permitted, performing a u-turn in a location where u-turns are not permitted and driving in a bus lane.

While certain embodiments described hereinafter include a vehicle detector (i.e., a vehicle detection device other than a digital camera) to detect presence of a vehicle in a zone of interest or a parking bay, other embodiments do not specifically require a vehicle detector. For example, one or more digital images may be used to establish presence of a vehicle in a zone of interest or a parking bay or to establish that a potential violation is being committed.

Examples of vehicle detectors and other equipment (e.g., a central computer server and portable apparatuses for retrieving data from the vehicle detectors) that may be used to practice embodiments of the present invention are described in International Patent Publication No. WO 2005/111963, published on 24 Nov. 2005, which is incorporated herein by reference. The vehicle detectors described in International Patent Publication No. WO 2005/111963 are battery-powered, communicate wirelessly, and are typically installed in, on or under the ground (i.e., subterraneously), either within or adjacent to parking bays or other zones of interest. These vehicle detectors can advantageously be utilized in situations that include both metered and unmetered parking bays. Unmetered parking bays include parking bays for which no charge is levied but for which a limited maximum parking time applies. However, those skilled in the art will appreciate that embodiments of the present invention may be practiced using numerous other arrangements for detecting vehicle presence and overstay. For example, embodiments of the present invention may optionally be integrated with parking payment systems such as parking meters.

Embodiments of the present invention generally use time-stamps to define the time and/or date certain events occur. A time-stamp is typically associated with data and may define the time and/or date that the data was generated. For example, a time-stamp may be used to define the date and time of capture of a digital image. A time-stamp may also be used to define the date and time of detection of a parking violation.

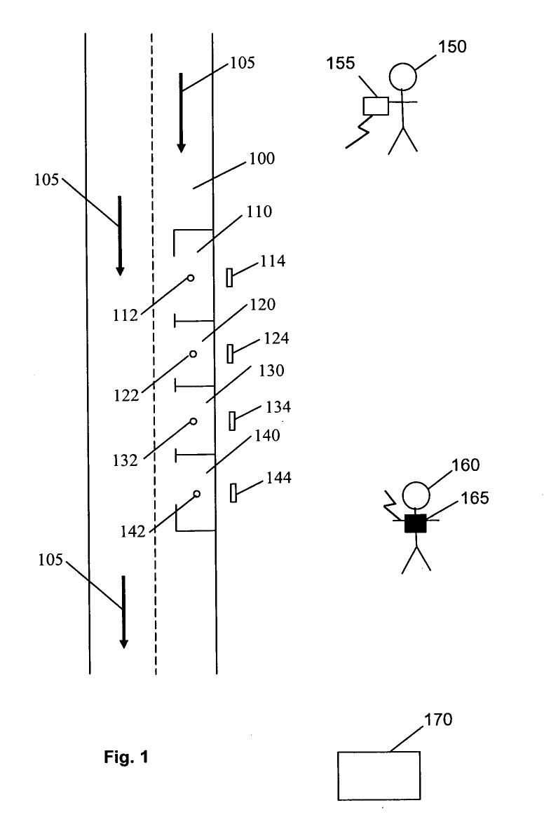

FIG. 1 shows a roadway 100 having two lanes and traffic flow in the direction of the arrows 105. A number of parking bays 110, 120, 130 and 140 are located on the side of the left-hand lane of the roadway 100. Vehicle detectors 112, 122, 132 and 142 and parking bay identification plates 114, 124, 134 and 144 are associated with parking bays 110, 120, 130 and 140, respectively.

The vehicle detectors 112, 122, 132 and 142 detect the presence of vehicles in a respective parking bay and determine and record data relating to instances when a vehicle has overstayed an allowed parking duration. The data relating to instances of overstay are wirelessly collected from the vehicle detectors 112, 122, 132 and 142 by one or more portable data collection apparatuses (e.g., the portable data collection apparatus 155 carried by a person 150) and are then transferred to a central computer server 170. Data transfer from a portable data collection apparatus 155 to the central computer server 170 may be practiced using any convenient means including, but not limited to: a wireless network or link (e.g., a GPRS network, a wireless Bluetooth link), a removable memory means (e.g., a memory card or memory stick), and a hardwired link (e.g., a docking cradle). Alternatively, the data may be transferred from the vehicle detectors 112, 122, 132 and 142 to the central computer server 170 via fixed location data collectors and/or repeaters.

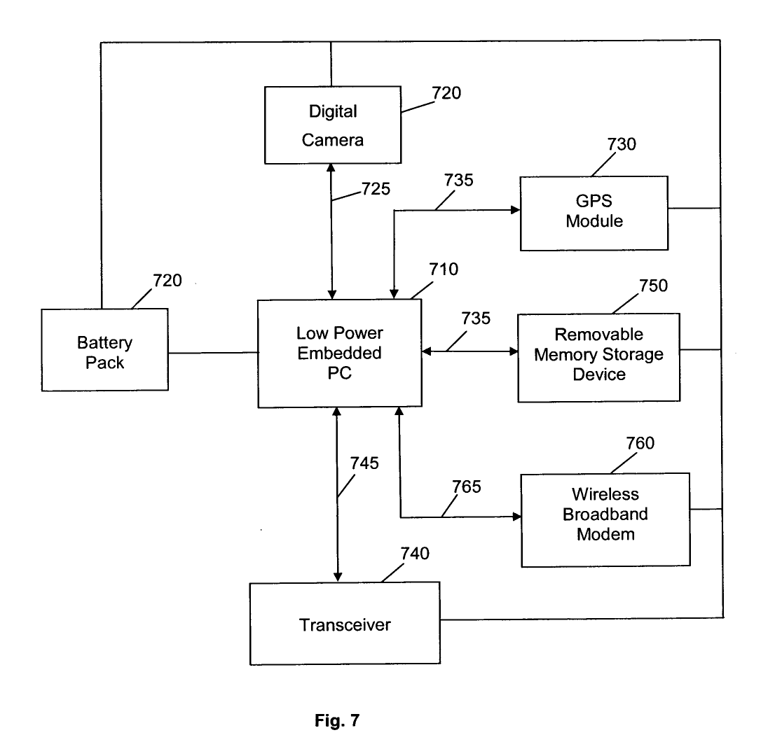

In addition to the foregoing overstay detection, visual images of vehicles present in the parking bays 110, 120, 130 and 140 are captured periodically or irregularly and transferred to the central computer server 170. The visual images typically comprise digital images or photographs captured by a digital camera system such as the body-mounted camera system 165 carried by a person 160 and described hereinafter with reference to FIG. 7. The body-mounted camera system 165 is typically carried by a person on foot. However, those skilled in the art will appreciate that embodiments of the present invention may be practiced using numerous other arrangements for capturing visual images of vehicles in the parking bays 110, 120, 130 and 140. For example, in certain instances, it may be suitable to use a fixed location camera. In certain other instances, the camera may be vehicle-mounted as opposed to body-mounted on a person.

To identify all overstay offenders, visual images of vehicles in the parking bays 110, 120, 130 and 140 should preferably be captured at least once in each period of time that matches the maximum parking duration for the parking bays 110, 120, 130 and 140. For example, if the maximum parking duration in the parking bays 110, 120, 130 and 140 is 1 hour, visual images of vehicles in the parking bays 110, 120, 130 and 140 should be captured at least once every hour.

Transfer of the captured visual images from the digital camera system 165 to the central computer server 170 may be practiced using any convenient means including, but not limited to: a wireless network or link, a removable memory means (e.g., a hard disk, memory card or memory stick), and a hardwired link (e.g., a docking cradle).

Real-time clocks in the vehicle detectors 112, 122, 132 and 142 are synchronized with a real-time clock in the portable data collection apparatus 155. Similarly, real-time clocks in the portable data collection apparatus 155 and the body-mounted digital camera system 165 are synchronized with a real-time clock in the central computer server 170. Real-time clock synchronization may, for example, be performed at the time of data transfer between the respective units or on a scheduled basis.

Synchronization of the various real-time clocks enables time-based correlation of data relating to a potential parking violation with visual images of the vehicle that committed the potential violation (e.g., overstay). Processing of the visual images (e.g., zooming, number plate recognition, and parking bay plate recognition), in either a computer automated or partly computer-automated process at the central computer server 170, advantageously enables the vehicle and parking bay to be uniquely identified for enforcement purposes. Alternatively, or in addition, the digital camera system 165 may communicate wirelessly with the vehicle detectors 112, 122, 132 and 142 when in close proximity to the vehicle detectors 112, 122, 132 and 142 for the purpose of geo-locating the digital camera system 165 relative to the vehicle detectors 112, 122, 132 and 142.

The images also advantageously provide visual evidence for supporting prosecution.

Collection of data relating to overstay instances using the portable data collection apparatus 155 and capture of the visual images may be performed independently or asynchronously with reference to one another. That is, these tasks may be performed at different times and/or by different people. However, those skilled in the art will appreciate that the same person may perform both tasks.

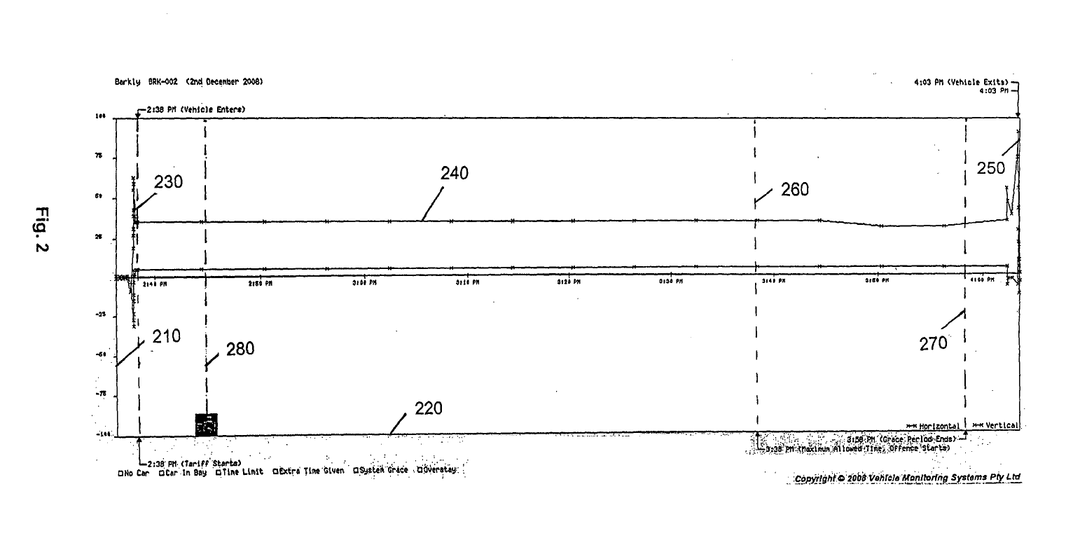

FIG. 2 shows a graph of a magnetic reading file in which the vertical axis 210 represents values of magnetic flux or magnetic field strength measured by a vehicle detector having a magneto-resistive or magnetic field strength sensor as a function of time, which is depicted on the horizontal axis 220. The graphical representation of FIG. 2 may be generated by the central computer server 170.

Referring to FIG. 2, a vehicle enters the parking bay at 2:38 pm, which is evidenced by variations 230 in magnetic flux. Continued presence of the vehicle in the parking bay is evidenced by a relatively static value of magnetic flux 240. Exiting of the vehicle from the parking bay is evidenced by the variations 250 in magnetic flux that occur at 4:03 pm.

Superimposed on the magnetic reading graph of FIG. 2 is the maximum allowable parking time 260, which expired at 3:38 pm. Continued presence of the vehicle in the parking bay thereafter (i.e., the portion of the trace 240 to the right of the time 260 in FIG. 2) thus constitutes a potential violation. A grace period is applied, which ends at time 270 (3:58 pm).

The graph of FIG. 2 further shows that one or more visual image/s of the vehicle were captured at time 280, which is while the vehicle was in the parking bay but before a potential violation occurred. This visual evidence, which enables unique identification of the vehicle, together with data relating to overstay of the vehicle provides sufficient information for enforcement and prosecution.

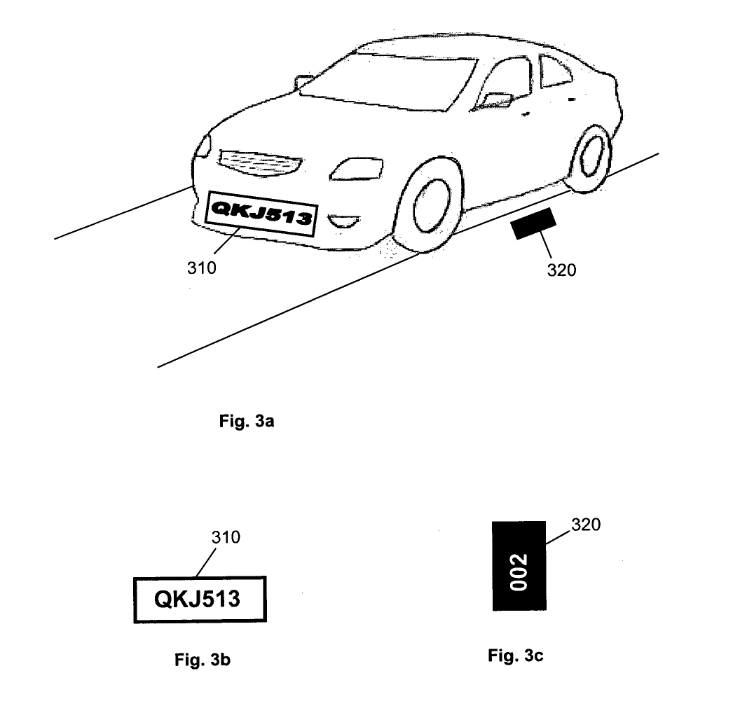

FIGS. 3a, 3b and 3c are visual images of a vehicle in a parking bay. The actual visual images in embodiments of the present invention comprise digital photographs. However, FIGS. 3a, 3b and 3c are presented as line drawings for purposes of reproducibility.

FIG. 3a shows the vehicle in a parking bay identifiable by a number on the bay plate 320. A bay plate is typically affixed to the pavement adjacent to a parking bay and indicates a unique bay number in a sequence of unique bay numbers for parking bays in the vicinity. In order to preserve uniqueness, a parking bay number may need to be accompanied by additional data (e.g., a street name or parking area number). The vehicle is uniquely identifiable by means of its license registration plate 310.

FIG. 3b shows an enlarged (zoomed-in) representation of the license registration plate 310 of the vehicle. The zooming is performed by the central computer server 170 so that the license registration number of the vehicle can be visually determined by an operator. In an alternative embodiment, the license registration number of the vehicle is determined by license registration plate recognition software executed by the central computer server 170. This constitutes unique identification of the vehicle.

FIG. 3c shows an enlarged (zoomed-in) representation of the bay plate 320 of the parking bay the vehicle is present in. The zooming is performed by the central computer server 170 so that the bay plate number can be visually determined by an operator. In an alternative embodiment, the bay plate number is determined by numerical recognition software executed by the central computer server 170.

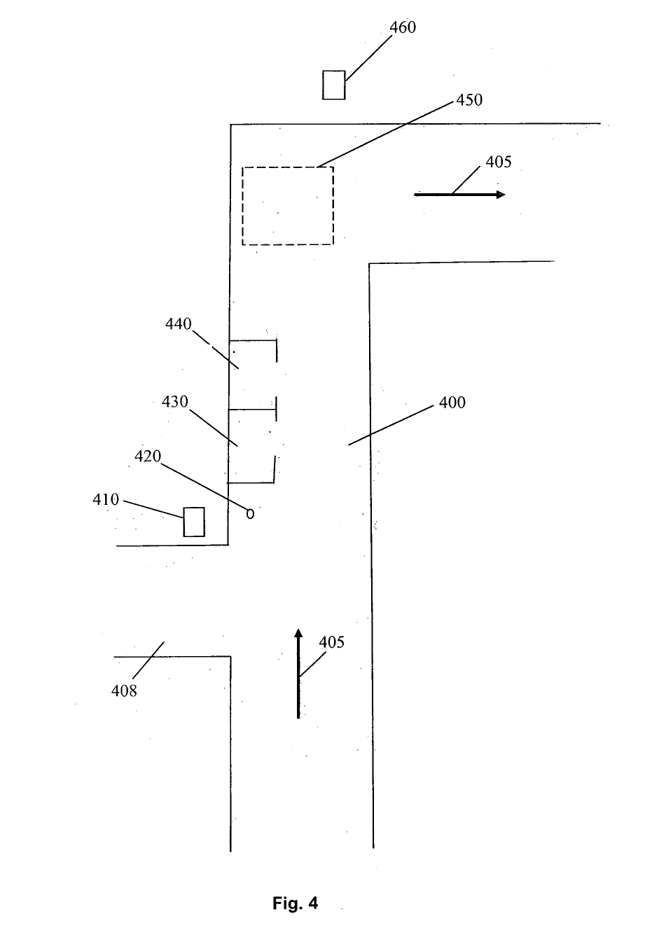

FIG. 4 is an overhead view of an application of an embodiment of the present invention, which employs a fixed location camera positioned remotely from the location at which the potential violations may occur.

Referring to FIG. 4, a roadway 400 has traffic flow in the direction of the arrows 405. Parking bays 430 and 440 are located on the left side of the roadway 400. An automatic teller machine (ATM) 410 is located near the parking bays 430 and 440 but the area directly in front of the ATM 410 in the roadway 400 (i.e., the zone of interest) is not a parking bay. On account of the ATM 410 being located on a corner (intersection) of the roadways 400 and 408, safety requirements dictate that vehicles should not be allowed to stop or park directly in front of the ATM 410.

A vehicle detector 420 is positioned to detect vehicles committing a potential violation by parking or stopping in the zone of interest in front of the ATM 410. However, positioning of a fixed location camera to capture images of vehicles as relevant potential parking violations occur is more problematic on account of the situational layout. For example, a vehicle legitimately parked in the parking bay 430 and vehicles entering the roadway 400 from the side street 408 may obscure the license registration plate of a vehicle parked or stopped in the zone of interest in front of the ATM 420. Accordingly, the fixed location camera 460 is positioned as shown in FIG. 4.

Data relating to potential violations is wirelessly collected from the vehicle detector 420 by a portable data collection apparatus and transferred to central computer server (not shown in FIG. 4), as described hereinbefore with reference to FIG. 1. Alternatively, the data relating to potential violations may be wirelessly collected from the vehicle detector 420 by a fixed location repeater/concentrator and transferred to the central computer server (not shown in FIG. 4).

A sequence of time-stamped visual images of vehicles advancing from the zone of interest in front of the ATM 420 until they pass through an identification zone 450 is captured by the fixed camera 460. The identification zone 450 is selected to provide suitable images for extracting license plate information.

In a similar manner as described hereinbefore with reference to FIG. 1, vehicles that have committed a potential parking violation in front of the ATM 420 are uniquely identified based on their license registration number, which is extracted from images captured in the identification zone 450 by the fixed location camera 460. A sequence of images of the vehicle advancing from the location of the potential violation (i.e., the zone of interest) to the identification zone 450 provides visual evidence that the uniquely identified vehicle is the vehicle that committed the potential violation.

In an alternative embodiment, the arrangement described hereinbefore with reference to FIG. 4 may be performed without using the vehicle detector 420. In this embodiment, potential violations are detected or identified either at the site of the fixed location camera 460 (e.g., computer software automated) or at the central computer server (e.g., manually by an operator or computer software automated). In one implementation, a computer system such as the embedded personal computer (PC) 710 referred to hereinafter with reference to FIG. 7 is located at the site of the fixed location camera 460. The computer system receives digital images from the fixed location camera 460 and performs image processing techniques for detecting potential violations. For example, detection of a particular vehicle present in the zone of interest in multiple images that span a predetermined time period (e.g., at least 1 minute) will cause a potential violation to be reported to the central computer server. Alternatively, similar processing may be performed by the central computer server.

In instances where the data link between the computer system located at or near the site of the fixed location camera 460 and the central computer server is of lower bandwidth, the computer system may only send low-data images (e.g., thumbnail images) to the central computer server initially. Upon detection or initial qualification of a potential violation, the central computer server may request additional images or larger images from the computer system located at or near the site of the fixed location camera 460.

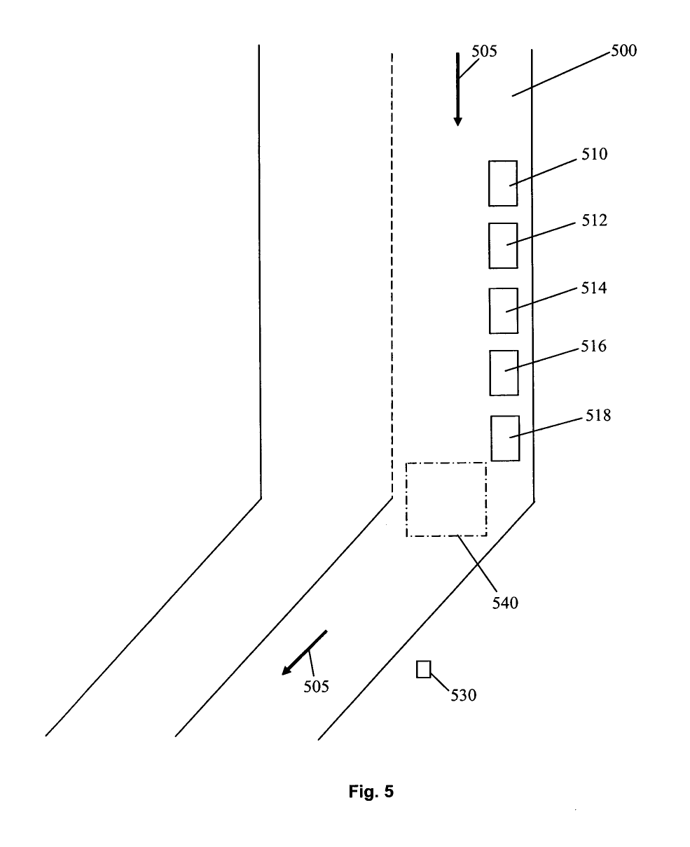

FIG. 5 is an overhead view of another application of an embodiment of the present invention, which employs a fixed location camera positioned remotely from the location of the potential violation.

Referring to FIG. 5, a roadway 500 has traffic flow in the direction of the arrows 505. Vehicles 510, 512 . . . 518 are shown parked on the left side of the roadway 500. However, the roadway 500 is designated as a clearway (i.e., no parking) at various times of the day (e.g., during peak traffic periods). For the purpose of describing the present embodiment, it is assumed that the vehicles 510, 512 . . . 518 are committing a parking violation.

Vehicle detectors (not shown in FIG. 5) are positioned at approximately parking bay size intervals (i.e., zones of interest) along the left side of the roadway 500 (e.g., under the vehicles 510, 512 . . . 518) to detect presence of the vehicles 510, 512 . . . 518 when the roadway 500 is designated a clearway.

However, positioning of a fixed location camera to capture images of the vehicles 510, 512 . . . 518 that are suitable for unique identification of the vehicles 510, 512 . . . 518 is problematic on account of the situational layout. For example, the license registration plate of vehicle 514 is obscured by the vehicles 512 and 516. Accordingly, a fixed location camera 530 is positioned as shown in FIG. 5.

Data relating to potential violations is wirelessly collected from the vehicle detectors (not shown in FIG. 5) by a portable data collection apparatus and transferred to a central computer server (not shown in FIG. 5), as described hereinbefore with reference to FIG. 1. Alternatively, the data relating to potential violations may be wirelessly collected from the vehicle detectors (not shown in FIG. 5) by a fixed location repeater/concentrator and transferred to the central computer server (not shown in FIG. 5)

A sequence of time-stamped visual images of vehicles advancing from where they were parked (i.e., zones of interest) on the left side of the roadway 500 until they pass through an identification zone 540 is captured by the fixed camera 530. In an alternative embodiment, the sequence of time-stamped visual images may be captured as vehicles approach the parking bay or other zone of interest. The identification zone 540 is selected to provide suitable images for extracting license plate information.

In a similar manner as described hereinbefore with reference to FIG. 1, vehicles that have committed a potential parking violation are uniquely identified based on their license registration number, which is extracted from images captured in the identification zone 540. A sequence of images of the vehicle advancing from the location of potential violation (i.e., the zone of interest) to the identification zone 540 provides visual evidence that the uniquely identified vehicle is a vehicle that committed the potential violation.

In an alternative embodiment, the arrangement described hereinbefore with reference to FIG. 5 may be performed without vehicle detectors. In this alternative embodiment, potential violations are detected either at the site of the fixed location camera 530 (e.g., computer software automated) or at the central computer server (e.g., manually by an operator or computer software automated). In one implementation, a computer system such as the embedded personal computer (PC) 710 referred to hereinafter with reference to FIG. 7 is located at the site of the fixed location camera 530. The computer system receives digital images from the fixed location camera 530 and performs image processing techniques for detecting potential violations. For example, detection of a particular vehicle present in the zone of interest in multiple images that span a predetermined time period (e.g., at least 1 minute) will cause a potential violation to be reported to the central computer server. Alternatively, similar processing may be performed by the central computer server.

In instances where the data link between the computer system located at or near the site of the fixed location camera 530 and the central computer server is of lower bandwidth, the computer system may only send low-data images (e.g., thumbnail images) to the central computer server initially. Upon detection or initial qualification of a potential violation, the central computer server may request additional images or larger images from the computer system located at or near the site of the fixed location camera 530.

Embodiments of the present invention such as those described hereinbefore with reference to FIGS. 4 and/or 5 (or similar) may be used to uniquely identify numerous different potential violations such as potential violations occurring in or at No Stopping Zones, No Parking Zones, Loading Zones, Taxi Zones, Bus Zones, Minibus Zones, Mail Zones, Works Zones, Permit Zones, Safety Zones, Bus Lanes, Transit Lanes, Truck Lanes, Children's Crossings, Pedestrian Crossings, Clearways and Intersections.

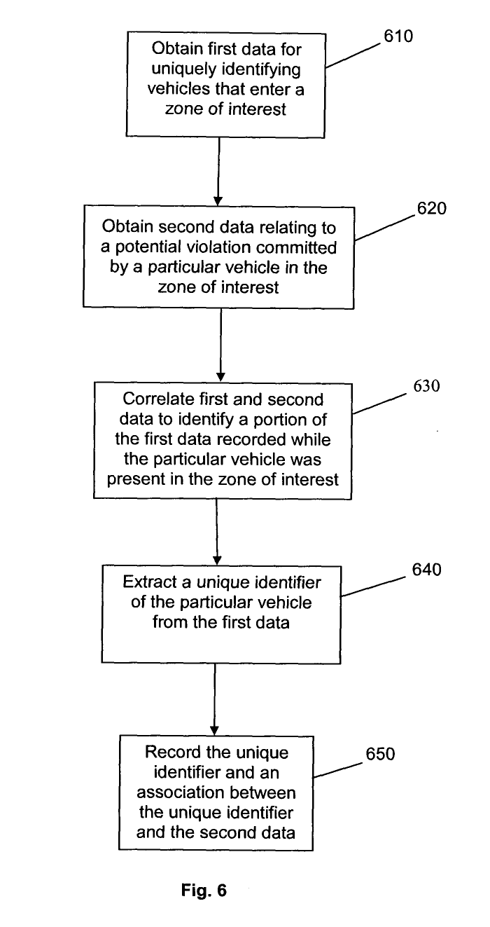

FIG. 6 is a flow diagram of a method for uniquely identifying a vehicle that has committed a potential violation in accordance with embodiments of the present invention.

Referring to FIG. 6, first data for uniquely identifying vehicles that enter a zone of interest is obtained at step 610. The first data may, for example, comprise visual images (e.g., a sequence of digital images captured by a digital camera). The digital images may be recorded by a portable or fixed digital camera.

At step 620, second data relating to a potential violation committed by a particular vehicle in the zone of interest is obtained. The method may include the further step (prior to step 620) of determining that a particular vehicle has committed a potential violation in the zone of interest and recording, independently of the first data, second data relating to the potential violation.

The first and second data are correlated at step 630 to identify a portion of the first data that was recorded while the particular vehicle was present in the zone of interest. Correlation of the first and second data may comprise identifying one or more digital images that were captured while the particular vehicle was committing the potential violation.

At step 640, a unique identifier of the particular vehicle is retrieved or extracted from the portion of first data identified in step 630. Unique identification of the vehicle may be performed by retrieval of the license plate registration number from at least one of the digital images, either manually by an operator or by applying an automated number plate recognition technique to the digital image/s. In certain embodiments, a fixed location camera may be specifically positioned to capture/provide suitable digital images for retrieving or extracting license plate registration numbers.

The unique identifier and an association between the unique identifier and the second data are recorded at step 650.

The step of correlating the first and second data may be performed after the vehicle has left the zone of interest. Indeed, steps 630 to 650 may advantageously be performed long after the violation occurred, thus obviating the need for an enforcement officer to attend the actual location at which the potential violation occurred.

The first and second data are recorded independently of each other or asynchronously, thus making it possible to record the first and second data at different points in time and/or by different people. The first and second data may be separately recorded in separate memory storage devices. The first data may be obtained and/or recorded prior to, during, or after obtaining and/or recording the second data.

The method may comprise the further step of uniquely identifying the zone of interest based on the identified portion of first data (e.g., one or more of the digital images). The zone of interest may comprise a parking bay and the zone of interest may be uniquely identified by retrieving or extracting a unique parking bay identification number from the identified portion of first data.

FIG. 7 is a schematic block diagram of a body-mounted camera system 700 which may be used to practise the body-mounted camera system 165 carried by a person 160, as described hereinbefore with reference to FIG. 1.

Referring to FIG. 7, the body-mounted camera system 700 comprises a low-power embedded personal computer (PC) 710. The AMD LX-800 processor has been used to practice embodiments of the present invention with the embedded PC configured to run the Linux™ operating system.

At least one Internet Protocol (IP) 5 Mega pixel digital camera 720 is coupled to the embedded PC 710 via an Ethernet link 725 for capturing digital images. The digital camera 720 preferably has an automatically adjustable wide angle lens to enable image capture over a wide range of distance. A continuous sequence of images may be captured with an image captured every 500 ms.

A large capacity removable memory storage device 730 for storing captured digital images is also coupled to the embedded PC 710 via a Universal Serial Bus (USB) data link 735. The removable memory storage device may, for example, comprise a memory card or memory stick, a conventional portable hard disk drive, or a solid state hard disk drive.

A radio transceiver 740 for short range communication with vehicle detectors is coupled to the embedded PC 710 via a Universal Serial Bus (USB) or serial (RS-232) data link 745. The body-mounted camera system 700 obtains geo-location and other data from the vehicle detectors and the vehicle detectors real-time clocks are updated or synchronised using the radio transceiver 740. A UHF radio transceiver is generally used in embodiments of the present invention, particularly for communicating with in-ground vehicle detectors. The body-mounted camera system 700 typically communicated with the vehicle detectors approximately every 5 seconds.

An optional Global Positioning System (GPS) module 730 may also be coupled to the embedded PC 710 via a Universal Serial Bus (USB) or serial (RS-232) data link 735. The GPS module 730 provides accurate time source and additional data for geo-location of the digital camera 720 and images taken therewith.

An optional wireless broadband modem 760 may also be coupled to the embedded PC 710 via a Universal Serial Bus (USB) data link 765. The wireless broadband modem 760 may optionally be used for remote monitoring of the body-mounted camera system 700 and for performing real-time clock synchronization.

A lithium ion battery pack 720 provides power for the body-mounted camera system 700 and has sufficient capacity to support a day's use of the body-mounted camera system 700.

The embedded PC 710 controls the digital camera 720 and saves time-stamped images to the removable memory storage device 730. The embedded PC 710 also controls the radio transceiver 740 and saves time-stamped geo-location data based on the vehicle detectors communicated with at short range.

The body-mounted camera system 700 may be mounted in a backpack with the digital camera 720 mounted on a shoulder strap of the backpack.

For the case of fixed location digital cameras, the battery pack 720 and GPS module 730 are unnecessary. The removable memory storage device 750 may also be replaced by a permanent data link (e.g., an Ethernet or wireless data link) in this instance.

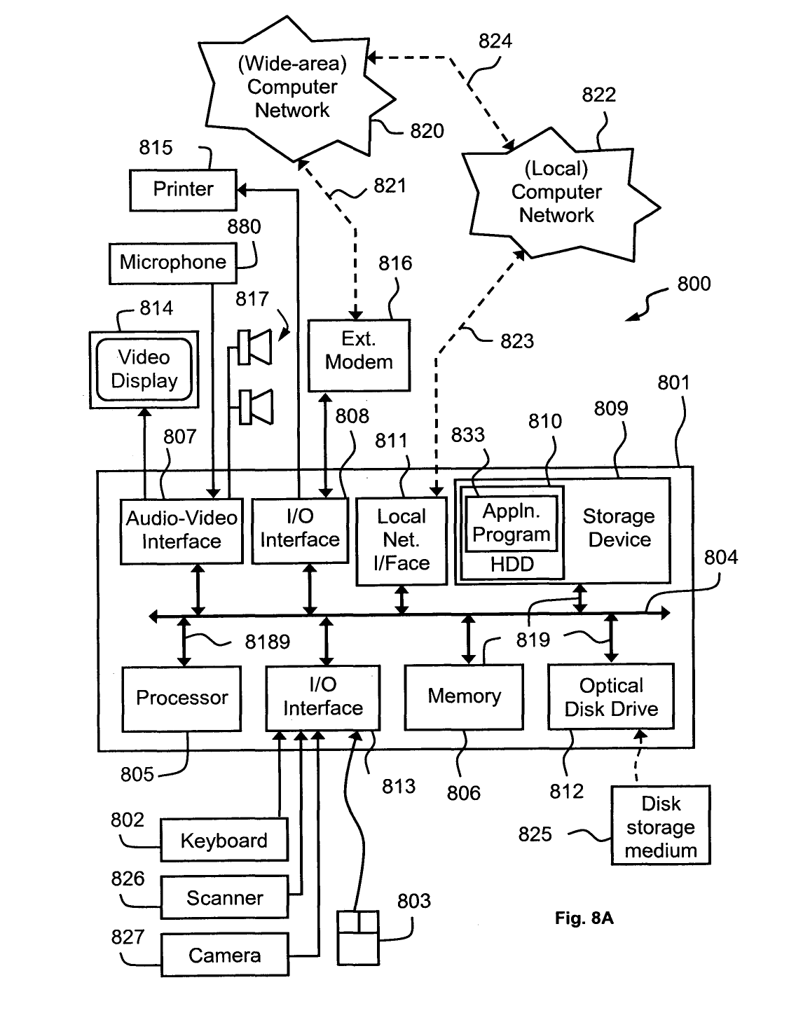

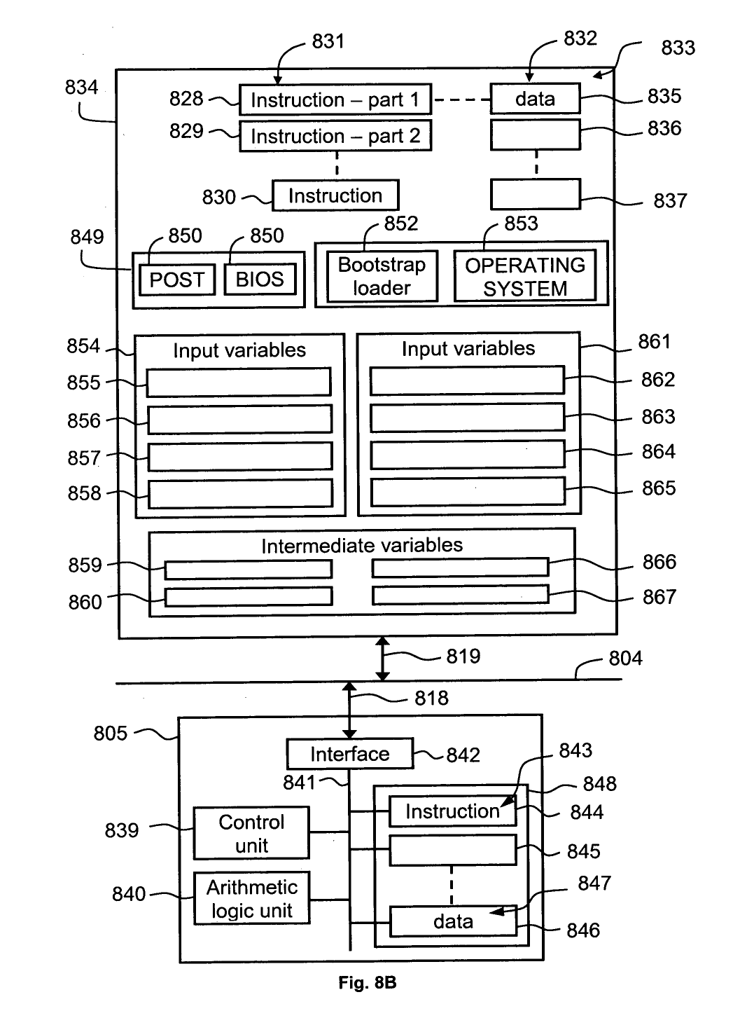

Potential violation data, digital images and geo-location data are collected on a central computer server such as the computer system described hereinafter with reference to FIG. 8.

For each potential violation event, an automated search is performed to find geo-location data from a camera system that was close to or at the location where the event occurred. In the case of fixed location cameras, the geo-location is always known. An operator then views an initial image presented by the central computer server that was captured at or near the location of the potential violation (i.e., the zone of interest) and steps through successive images immediately before and after the initial image in the sequence of captured images. The operator selects one or more relevant and suitable images that show the unique license plate registration number of the vehicle, the parking bay number (if applicable), and any parking permits affixed to the vehicle that would result in non-enforcement. The operator then reads and records (enters) the unique license plate registration number of the vehicle, parking bay number (if applicable), and permit number (if applicable). The data recorded by the operator is automatically associated with the related potential violation data. In other embodiments, license plate number and bay plate number recognition software may be executed by the central computer server to automate or partially automate the process.

If no geo-location records from a camera system are found that are at or close to the location where the potential violation occurred, the potential violation is not reported by the central computer server.

Geo-location methods include, but are not limited to: GPS, GPS plus dead reckoning, GPS plus inertial navigation, WiFi geo-location, ultra wide band geo-location, image-based landmark auto identification, RFID tags buried in pavement or roadway, image capture of 2D or 3D barcodes, automatic optical character recognition (OCR) of images of parking bay number plates, and combinations of the foregoing methods. However, it should be noted that geo-location information may not be necessary in certain embodiments of the present invention.

Address details of the registered owner of a uniquely identified vehicle that has committed a potential violation may be obtained from the relevant government authority for delivering an infringement notice or parking citation or parking fine.

Embodiments of the present invention may be practised using a computer system 800, such as that illustrated in FIGS. 8A and 8B of the accompanying drawings. FIGS. 8A and 8B collectively form a schematic block diagram of a general purpose computer system 800, with which embodiments of the present invention can be practiced. In particular, the computer system 800 may be used to practise the central computer server referred to in embodiments described hereinbefore (e.g., the central computer server 170 of FIG. 1). A similar but scaled-down and low-power version of the computer system 800 may be used to practise the camera system 700 of FIG. 7. Such a scaled-down version would exclude certain components shown in FIG. 8, including: the printer 815, the microphone 880, the video display 814, the keyboard 802, the scanner 826, and the mouse 803.

As seen in FIG. 8A, the computer system 800 is formed by a computer module 801, input devices such as a keyboard 802, a mouse pointer device 803, a scanner 826, a camera 827, and a microphone 880, and output devices including a printer 815, a display device 814 and loudspeakers 817. An external Modulator-Demodulator (Modem) transceiver device 816 may be used by the computer module 801 for communicating to and from a communications network 820 via a connection 821. The network 820 may be a wide-area network (WAN), such as the Internet or a private WAN. Where the connection 821 is a telephone line, the modem 816 may be a traditional “dial-up” modem. Alternatively, where the connection 821 is a high capacity (e.g., cable) connection, the modem 816 may be a broadband modem. A wireless modem may also be used for wireless connection to the network 820.

The computer module 801 typically includes at least one processor 805 and a memory 806, for example, formed from semiconductor random access memory (RAM) and semiconductor read only memory (ROM). The at least one processor 805 may comprise multiple processors or multiple processor cores, for example, arranged in a pipelined or parallel configuration. The module 801 also includes an number of input/output (I/O) interfaces including an audio-video interface 707 that couples to the video display 814, loudspeakers 817 and microphone 880, an I/O interface 813 for the keyboard 802, mouse 803, scanner 826, camera 827 and optionally a joystick (not illustrated), and an interface 808 for the external modem 816 and printer 815. In some implementations, the modem 816 may be incorporated within the computer module 801, for example within the interface 708. The computer module 801 also has a local network interface 811 which, via a connection 823, permits coupling of the computer system 800 to a local computer network 822, known as a Local Area Network (LAN). As also illustrated, the local network 822 may also couple to the wide network 820 via a connection 824, which would typically include a so-called “firewall” device or device of similar functionality. The interface 811 may be formed by an Ethernet™ circuit card, a Bluetooth™ wireless arrangement or an IEEE 802.11 wireless arrangement.

The interfaces 808 and 813 may afford either or both of serial and parallel connectivity, the former typically being implemented according to the Universal Serial Bus (USB) standards and having corresponding USB connectors (not illustrated). Storage devices 809 are provided and typically include a hard disk drive (HDD) 810. Other storage devices such as a floppy disk drive and a magnetic tape drive (not illustrated) may also be used. An optical disk drive 812 is typically provided to act as a non-volatile source of data. Portable memory storage devices, such optical disks (e.g., CD-ROM, DVD), USB-RAM (e.g., memory cards and memory sticks), floppy disks, and portable hard disks may then be used as appropriate sources of data to the computer system 800. For example, the removable memory storage device 750 of the camera system 700 of FIG. 7 may be interfaced to the computer system 800 via one of the interfaces 808 and 813 for transferring image data to the computer system 800.

The components 805 to 813 of the computer module 801 typically communicate via an interconnected bus 804 and in a manner which results in a conventional mode of operation of the computer system 800 known to those skilled in the relevant art. Examples of computers on which the described arrangements or embodiments can be practised include IBM-PC's and compatibles, Sun Sparcstations, Apple Mac™ or similar computer systems.

The methods and/or processes described hereinbefore may be implemented as software, such as one or more application programs 833 executable within the computer system 800. In particular, certain of the steps of the method described hereinafter with reference to FIG. 6 (e.g., steps 630, 640 and 650) may be implemented as programmed instructions 831 in the software 833 that are executed by the computer system 800. The software instructions 831 may be formed as one or more code modules, each for performing one or more particular tasks. The software may also be divided into two separate parts, in which a first part and the corresponding code modules performs the methods described hereinafter and a second part and the corresponding code modules manage a user interface between the first part and the user.

The software 833 is generally loaded into the computer system 800 from a computer readable medium (the software 833 and computer readable medium together form a computer program product), and is then typically stored in the HDD 810, as illustrated in FIG. 8A, or the memory 806, after which the software 833 can be executed by the computer system 800. In some instances, the application programs 833 may be supplied to the user encoded on one or more CD-ROM 825 and read via the corresponding drive 812 prior to storage in the memory 810 or 806. Alternatively the software 833 may be read by the computer system 800 from the networks 820 or 822 or loaded into the computer system 800 from other computer readable media. Computer readable storage media refers to any storage medium that participates in providing instructions and/or data to the computer system 800 for execution and/or processing. Examples of such storage media include floppy disks, magnetic tape, CD-ROM, a hard disk drive, a ROM or integrated circuit, USB memory, a magneto-optical disk, or a computer readable card such as a PCMCIA card and the like, whether or not such devices are internal or external to the computer module 801. Examples of computer readable transmission media that may also participate in the provision of software, application programs, instructions and/or data to the computer module 801 include radio or infra-red transmission channels as well as a network connection to another computer or networked device, and the Internet or Intranets including email transmissions and information recorded on Websites and the like.

The second part of the application programs 833 and the corresponding code modules mentioned above may be executed to implement one or more graphical user interfaces (GUIs) to be rendered or otherwise represented upon the display 814. Through manipulation of typically the keyboard 802 and the mouse 803, a user of the computer system 800 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 817 and user voice commands input via the microphone 880.

FIG. 8B is a detailed schematic block diagram of the at least one processor 805 and a “memory” 834. While only a single processor is shown in FIGS. 8A and 8B, those skilled in the art will appreciate that multiple processors or processor cores are used to practise embodiments of the present invention. The memory 834 represents a logical aggregation of all the memory devices (including the HDD 810 and semiconductor memory 806) that can be accessed by the computer module 801 in FIG. 8A.

When the computer module 801 is initially powered up, a power-on self-test (POST) program 850 executes. The POST program 850 is typically stored in a ROM 849 of the semiconductor memory 806. A program permanently stored in a hardware device such as the ROM 849 is sometimes referred to as firmware. The POST program 850 examines hardware within the computer module 801 to ensure proper functioning, and typically checks the processor 805, the memory (809, 806), and a basic input-output systems software (BIOS) module 851, also typically stored in the ROM 849, for correct operation. Once the POST program 850 has run successfully, the BIOS 851 activates the hard disk drive 810. Activation of the hard disk drive 810 causes a bootstrap loader program 852 that is resident on the hard disk drive 810 to execute via the processor 705. This loads an operating system 753 into the RAM memory 806 upon which the operating system 853 commences operation. The operating system 853 is a system level application, executable by the processor 805, to fulfill various high level functions, including processor management, memory management, device management, storage management, software application interface, and generic user interface.

The operating system 853 manages the memory 809, 806 in order to ensure that each process or application running on the computer module 801 has sufficient memory in which to execute without colliding with memory allocated to another process. Furthermore, the different types of memory available in the system 800 must be used properly so that each process can run effectively. Accordingly, the aggregated memory 834 is not intended to illustrate how particular segments of memory are allocated (unless otherwise stated), but rather to provide a general view of the memory accessible by the computer system 800 and how such is used.

The processor 805 includes a number of functional modules including a control unit 839, an arithmetic logic unit (ALU) 840, and a local or internal memory 848, sometimes called a cache memory. The cache memory 848 typically includes a number of storage registers 844-846 in a register section. One or more internal buses 841 functionally interconnect these functional modules. The processor 805 typically also has one or more interfaces 842 for communicating with external devices via the system bus 804, using a connection 818.

The application program 833 includes a sequence of instructions 831 that may include conditional branch and loop instructions. The program 833 may also include data 832 which is used in execution of the program 833. The instructions 831 and the data 832 are stored in memory locations 828-830 and 835-837 respectively. Depending upon the relative size of the instructions 831 and the memory locations 828-830, a particular instruction may be stored in a single memory location as depicted by the instruction shown in the memory location 830. Alternately, an instruction may be segmented into a number of parts each of which is stored in a separate memory location, as depicted by the instruction segments shown in the memory locations 828-829.

In general, the processor 805 is given a set of instructions which are executed therein. The processor 805 then waits for a subsequent input, to which it reacts to by executing another set of instructions. Each input may be provided from one or more of a number of sources, including data generated by one or more of the input devices 802, 803, data received from an external source across one of the networks 820, 822, data retrieved from one of the storage devices 806, 809 or data retrieved from a storage medium 825 inserted into the corresponding reader 812. The execution of a set of the instructions may in some cases result in output of data. Execution may also involve storing data or variables to the memory 834.

The embodiments disclosed hereinafter may use input variables 854 that are stored in the memory 834 in corresponding memory locations 855-858. The embodiments disclosed hereinafter may produce output variables 861 that are stored in the memory 834 in corresponding memory locations 862-865. Intermediate variables may be stored in memory locations 859, 860, 866 and 867.

The register section 844-846, the arithmetic logic unit (ALU) 840, and the control unit 839 of the processor 805 work together to perform sequences of micro-operations needed to perform “fetch, decode, and execute” cycles for every instruction in the instruction set making up the program 833. Each fetch, decode, and execute cycle comprises:

(a) a fetch operation, which fetches or reads an instruction 831 from a memory location 828;
(b) a decode operation in which the control unit 839 determines which instruction has been fetched; and
(c) an execute operation in which the control unit 839 and/or the ALU 840 execute the instruction.

Thereafter, a further fetch, decode, and execute cycle for the next instruction may be executed. Similarly, a store cycle may be performed by which the control unit 839 stores or writes a value to a memory location 832.

Each step or sub-process in the methods or processes described herein is associated with one or more segments of the program 833, and is performed by the register section 844-847, the ALU 840, and the control unit 839 in the processor 805 working together to perform the fetch, decode, and execute cycles for every instruction in the instruction set for the noted segments of the program 833.

A small number of methods and systems have been described hereinbefore for uniquely identifying vehicles that have committed a potential violation. The embodiments described hereinbefore may be practised independently of or in conjunction with various parking payment systems such as single or multi-bay parking meters.

In a pay parking system (e.g., single or multi-bay parking meters), vehicle presence (stay) data and unique vehicle identification data are recorded and forwarded to a central computer server as described hereinbefore with reference to FIG. 1. Parking meter paid/unpaid status data is also forwarded to the central computer server. The above-mentioned three types of data, which are independently and asynchronously obtained/recorded, are post-processed (i.e., after the violation event) by the central computer server. If the meter was unpaid at any time while the vehicle was present in the parking bay and unique vehicle identification data was recorded while the vehicle was present in the parking bay, the occurrence of a violation can be proved and further action against the vehicle owner can be taken, as appropriate.

The parking meter data may comprise time stamped records of transitions between paid and expired states. The parking meter data may further comprise records of when additional time is purchased (i.e., there may be no associated transition from expired to paid), which may be used to identify offences of meter feeding, if applicable. The parking meter data is typically stored and transferred to the central computer via a wireless or wired communication link. Alternatively, the parking meter data may be collected by a portable data collection device or apparatus (e.g., hand-carried or located in a vehicle) via a wireless (e.g., radio frequency or infrared) communications link. Alternatively, data transfer may be effected by removal of a portable storage device (e.g., a memory card or stick) from the parking meter and retrieval of the data from the portable storage device by or at the central computer.

The vehicle presence (stay) data is indicative of when the parking bay was occupied and vacant. Parking bay occupancy detection is performed using a vehicle detector comprising a sensor or sensing means, which may be deployed independently of a parking meter. Alternatively, the parking detector may be incorporated into or attached to a parking meter. Parking bay occupancy detection may be performed using a vehicle detector as described in International Patent Publication No. 2005/111963, which may be deployed in-ground and/or independently of a parking meter. Non-limiting examples of sensor technologies for performing vehicle presence detection include: ultra sonic, infrared, radar, capacitive, magnetic field disturbance or other methods. Data from the vehicle detectors can be collected wirelessly (i.e., via RF) using a portable data collection device, which may be either hand carried or vehicle mounted. Additionally vehicle detector data can be collected via fixed wireless communication infrastructure. Alternatively, a data collection device may be incorporated into or attached to a parking meter to collect data from a vehicle detector operating independently of the parking meter. In this case, data from the vehicle detector can be temporarily stored in the parking meter and forwarded to the central computer along with parking meter data at an appropriate time. In the case where the vehicle detector is incorporated into or attached to the parking meter, the occupancy data from the vehicle detector could be temporarily stored in the parking meter and then forwarded to the central computer along with parking meter paid/expired data at an appropriate time.

The unique vehicle identification data may comprise one or more images of the vehicle (e.g., while in a parking bay), which may be captured using a portable or fixed position digital camera. Preferably, the images provide sufficient detail to: uniquely identify the vehicle, identify the presence or absence of any parking permits (e.g., resident or disabled permits) that permit the vehicle to park or pay in a manner different than for vehicles generally.

The above three types of data, namely the parking meter data, the vehicle presence (stay) data, and the unique vehicle identification data are correlated or combined to identify a potential offence and identification details of the vehicle that committed the offence. Offences in which a vehicle remained parked in a parking bay for longer than a maximum time limit, irrespective of whether the meter was paid or expired at any and all times during presence of the vehicle in the parking bay, are detected and processed in the same way as in the case where there is no parking meter.

Offences relating to an expired meter can be identified as follows. The data provided by the vehicle detector enables determination of a period of time during which a single vehicle remains continuously parked in a parking bay. The data provided by the parking meter (i.e., paid/expired data) for the period of time the vehicle was continuously parking in the parking bay enables determination of whether the vehicle has at any time during its length of stay been parked without time having being paid for (i.e., detection of occurrence of a paid parking offence). A unique identifier of the vehicle (e.g., registration plate number) can be extracted from one or more images of the parking bay captured by a digital camera at any time from when the vehicle entered the parking bay to when the vehicle left the parking bay. Significantly, the image of the vehicle does not need to be captured at a time when the meter is expired. The steps of determining the length of stay of the vehicle in the parking bay and determining whether the parking meter was in an expired state for any period during the length of stay of the vehicle may be performed in reverse order. That is, periods of time during which the parking meter was expired may be determined prior to identification of any vehicle stay(s) that occurred fully or partially during the period of time the parking meter was expired.

The foregoing detailed description provides exemplary embodiments only, and is not intended to limit the scope, applicability or configurations of the invention. Rather, the description of the exemplary embodiments provides those skilled in the art with enabling descriptions for implementing an embodiment of the invention. Various changes may be made in the function and arrangement of elements without departing from the spirit and scope of the invention as set forth in the claims hereinafter. Features or steps described herein in relation to a particular embodiment may be applied to any of the other embodiments unless indicated to the contrary.

Use of the phrases “potential offence” or “potential violation” in the present specification is intended to convey that a final decision as to whether a violation or offence has been committed may yet be made. For example, grace periods and/or other considerations may be applied in deciding whether a potential violation has occurred and whether to proceed with prosecution. Use of the term “potential” is not intended to imply that the steps of the methods described herein are performed either prior or subsequently to occurrence of the potential offence or violation. In particular, in the method described hereinbefore with reference to FIG. 6, the steps of obtaining first data for uniquely identifying vehicles that enter a zone of interest (610) and obtaining second data relating to a potential violation committed by a particular vehicle in the zone of interest (620) may be performed prior or subsequently to occurrence of the potential offence or violation.

(Australia Only) In the context of this specification, the word “comprising” means “including principally but not necessarily solely” or “having” or “including”, and not “consisting only of”. Variations of the word “comprising”, such as “comprise” and “comprises” have corresponding meanings.

1. A method for uniquely identifying a vehicle that has committed a potential violation, said method comprising the steps of:
obtaining first data for uniquely identifying vehicles that enter a zone of interest;
obtaining second data relating to a potential violation committed by a particular vehicle in said zone of interest;
correlating said first and second data to identify a portion of said first data which was recorded while said particular vehicle was present in said zone of interest;
extracting a unique identifier of said particular vehicle from said first data; and
recording said unique identifier and an association between said unique identifier and said second data.

2. A method according to claim 1, comprising the further step of determining that said particular vehicle has committed a potential violation and recording, independently of said first data, said second data relating to said potential violation.

3. A method according to claim 1, wherein said first and second data are independently obtained.

4. A method according to claim 1, wherein said first and second data are recorded asynchronously.

5. A method according to claim 1, wherein said first and second data are separately recorded.

6. A method according to claim 1, wherein said step of obtaining said first data is performed prior to said step of obtaining said second data.

7. A method according to claim 1, wherein said first data comprises a sequence of digital images.

8. A method according to claim 7, wherein said first data is recorded at said zone of interest.

9. A method according to claim 7, wherein said first data is recorded at a location remote from said zone of interest.

10. A method according to claim 8, wherein said first data is recorded by a portable digital camera.

11. A method according to claim 2, wherein said step of determining that a particular vehicle has committed a potential violation is performed using a device adapted to detect presence of a vehicle in said zone of interest.

12. A method according to claim 11, wherein said device comprises a vehicle detector comprising a magneto-resistive sensor.

13. A method according to claim 1, wherein said step of correlating said first and second data is performed after said vehicle has left said zone of interest.

14. A method according to claim 7, wherein said step of correlating said first and second data comprises identifying one or more of said digital images that were captured while said particular vehicle was potentially committing said violation.

15. A method according to claim 1, wherein said step of extracting a unique identifier of said particular vehicle from said first data comprises the step of retrieving said vehicle's license registration number from at least one of said digital images.

16. A method according to claim 1, comprising the further step of extracting a unique identifier of said zone of interest based on said identified portion of first data.

17. A method according to claim 16, wherein said zone of interest comprises a parking bay and said step of extracting a unique identifier of said zone of interest based on said identified portion of first data comprises the step of retrieving a unique parking bay identification number from said identified portion of first data.

18. A computer system for uniquely identifying a vehicle that has committed a potential violation, said system comprising:
memory for storing data and software program instructions;
an input/output interface for receiving and transmitting data;
a video display for displaying information; and
at least one processor coupled to said memory, said input/output interface and said video display, said at least one processor programmed to:
obtain, via said input/output interface, first data for uniquely identifying vehicles that enter a zone of interest;
obtain second data relating to a potential violation committed by a particular vehicle in said zone of interest;
correlate said first and second data to identify a portion of said first data which was recorded while said particular vehicle was present in said zone of interest;
extract a unique identifier of said particular vehicle from said first data; and
record said unique identifier and an association between said unique identifier and said second data.

19. The computer system according to claim 18, wherein said first and second data are independently obtained.

20. A computer system according to claim 18, wherein said first and second data are obtained from separate distinct sources.

21. A computer system according to claim 18, wherein said first data is obtained prior to obtaining said second data.

22. A computer system according to claim 18, wherein said first data comprises a sequence of digital images.

23. A computer system according to claim 22, wherein said first data is recorded at said zone of interest.

24. A computer system according to claim 22, wherein said first data is recorded at a location remote from said zone of interest.

25. A computer system according to claim 18, wherein second data comprises magnetic data generated by a vehicle detector comprising a magneto-resistive sensor.

26. A computer system according to claim 22, wherein said at least one processor is programmed to identify one or more of said digital images that were captured while said particular vehicle was committing said potential violation.

27. A computer system according to claim 18, wherein said at least one processor is programmed to retrieve said vehicle's license registration number from at least one of said digital images.

28. A computer system according to claim 18, wherein said at least one processor is further programmed to extract a unique identifier of said zone of interest based on said identified portion of first data.

29. A computer system according to claim 28, wherein said zone of interest comprises a parking bay and said wherein said at least one processor is programmed to retrieve a unique parking bay identification number from said identified portion of first data.

30. A system for capturing images of vehicles to detect potential violations, said system comprising:
a battery pack for powering said system;
a digital camera for capturing images of said vehicles;
a removable memory storage device for storing images captured by said digital camera;
a radio transceiver for wirelessly communicating with a plurality of vehicle detectors; and
a low-power embedded personal computer coupled to said digital camera, said removable memory storage device, and said radio transceiver;
wherein said low-power embedded personal computer is adapted to:
capture images of vehicles in a zone of interest; and
record said captured images together with a timestamp on said removable memory storage device; and
wherein said system is mounted in a backpack and said digital camera is mounted on a shoulder strap of said backpack.

31. A method for uniquely identifying a vehicle that has potentially committed a parking violation, said method comprising the steps of:
obtaining first data for uniquely identifying vehicles that enter a parking bay;
obtaining second data for determining time of occupancy of said parking bay by a particular vehicle;
obtaining third data for determining expiry of paid parking periods for said parking bay;
correlating said first, second and third data to identify:
occupancy of said parking bay by said particular vehicle during expiry of a paid parking period; and
a portion of said first data which was recorded while said particular vehicle was present in said parking bay;
extracting a unique identifier of said particular vehicle from said first data; and
recording said unique identifier and an association between said unique identifier and at least one of said second and third data.

32. A method according to claim 31, wherein said first, second and third data are independently obtained.

33. A method according to claim 31, wherein said first, second and third data are recorded asynchronously.

34. A method according to claim 31, wherein said first data comprises a sequence of digital images.

35. A method according to claim 31, wherein said second data comprises data recorded by a vehicle detector comprising a magneto-resistive sensor.

36. A method according to claim 31, wherein said step of correlating said first, second and third data is performed after said vehicle has left said parking bay.

37. A method according to claim 34, wherein said step of correlating said first, second and third data comprises identifying one or more of said digital images that were captured while said particular vehicle was present in said parking bay.

38. A method according to claim 37, wherein said step of correlating said first, second and third data comprises identifying one or more of said digital images that were captured while said allowed parking period had not expired.

39. A method according to claim 31, comprising the further step of extracting a unique identifier of said zone of interest based on said identified portion of first data.

40. A computer system for uniquely identifying a vehicle that has potentially committed a parking violation, said system comprising:
memory for storing data and software program instructions;
an input/output interface for receiving and transmitting data;
a video display for displaying information; and
at least one processor coupled to said memory, said input/output interface and said video display, said at least one processor programmed to:
obtain first data for uniquely identifying vehicles that enter a parking bay;
obtain second data for determining time of occupancy of said parking bay by a particular vehicle;
obtain third data for determining expiry of paid parking periods for said parking bay;
correlate said first, second and third data to:
identify occupancy of said parking bay by said particular vehicle during expiry of a paid parking period; and
identify a portion of said first data which was recorded while said particular vehicle was present in said parking bay;
extract a unique identifier of said particular vehicle from said first data; and
record said unique identifier and an association between said unique identifier and at least one of said second and third data.
